(19) United States
(12) Patent Application Publication
(10) Pub. No.: US 2007/0009137 A1
(43) Pub. Date: Jan. 11, 2007

(54) Image generation apparatus, image generation method and image generation program

(75) Inventors: Takashi Miyoshi, Atsugi (JP); Hidekazu Iwaki, Tokyo (JP); Akio Kosaka, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: OLYMPUS CORPORATION, Tokyo (JP)

(21) Appl. No.: 11/519,333

(22) Filed: Sep. 12, 2006

Related U.S. Application Data
(63) Continuation of application No. PCT/JP05/02977, filed on Feb. 24, 2005.

(30) Foreign Application Priority Data
Mar. 16, 2004 (JP) 2004-073887

(51) Int. Cl. G06K 9/00

(52) U.S. Cl. 382/104; 382/154

(57) ABSTRACT

Provided are an image generation apparatus, image generation method and image generation program which are capable of displaying the relationship between a vehicle, et cetera, and an imaged image of the subject of monitoring in a manner intuitively comprehensible when displaying the monitoring subject, such as a vehicle, shop, surrounding area of a house, or street, by further comprising a movement information calculation unit for calculating movement information relating to a movement of an camera unit installation body based on either of viewpoint conversion image data generated by a viewpoint conversion unit, imaged image data expressing an imaged image, a spatial model, or mapped spatial data, and by a display unit displaying an image of an camera unit installation body model corresponding to the camera unit installation body and also movement information calculated by a movement information calculation unit.

### CROSS REFERENCE TO RELATED APPLICATIONS

This is a Continuation Application of PCT Application No. PCT/JP2005/002977, filed Feb. 24, 2005, which was not published under PCT Article 21(2) in English.

This application is based upon and claims the benefit of priority from the prior Japanese Patent Application No. 2004-073887, filed on Mar. 16, 2004, the entire contents of which are incorporated herein by reference.

### BACKGROUND OF THE INVENTION

1. Field of the Invention

The present invention relates to an image generation apparatus, an image generation method, and an image generation program that are for generating image data in order to display information relating to a movement of a body, when it moves, in an intuitively comprehensible manner based on a plurality of images captured by one or a plurality of cameras equipped on the body such as a vehicle.

2. Description of the Related Art

Conventionally, a monitor camera apparatus for monitoring a subject of monitoring in places such as a vehicle, store, surrounding area of a house, or street, for example, has captured a subject of monitoring by one or a plurality of cameras to display the images by a monitor apparatus. In such a monitor camera apparatus, if there are fewer number of the monitor apparatuses than there are number of cameras, e.g., one monitor apparatus for two cameras, then one monitor apparatus displays a plurality of captured images by integrating or changing over sequentially. Such a monitor camera apparatus, however, requires the difficulty of a managing person to consider a continuity of independently displayed images in order to monitor images from the respective cameras.

As a method for solving such a problem, a technique has been disclosed relating to a monitor camera apparatus for displaying a synthesized image by providing a very sense of actually viewing from a virtual view point. This is done by mapping input images from one or a plurality of cameras mounted on a vehicle, in a predetermined spatial model in a three-dimensional space, and generates and displays an image viewed from the arbitrary virtual view point the arbitrary virtual view point in the three-dimensional space by referring to the mapped spatial data (e.g., a patent document 1).

[Patent document 1] a registered Japanese patent No. 3286306

### SUMMARY OF THE INVENTION

The above described conventional monitor camera apparatus, however, has a problematic relationship between an camera unit mounting body, such as a vehicle mounting a camera, and a subject of monitoring which is captured by the camera.

In consideration of the above described deficiencies of the conventional technique, an aspect of the present invention is to provide an image generation apparatus, an image generation method, and an image generation program that are capable of displaying a relationship between an camera unit mounting body, such as a vehicle, and a captured image of a subject of monitoring, such as a vehicle, store, surrounding area of a house, or street, in an intuitively comprehensible manner when displaying the image of the subject of monitoring.

In order to address the situation described above, the present invention has adopted a comprisal as described below.

According to one aspect of the present invention, an image generation apparatus of the present invention comprises one or a plurality of camera units, being mounted onto an camera unit installation body, for imaging an image; a spatial reconstruction unit for mapping an image imaged by the camera unit in a spatial model; a viewpoint conversion unit for generating viewpoint conversion image data viewed from the arbitrary virtual view point the arbitrary virtual view point in a three-dimensional space based on spatial data mapped by the spatial reconstruction unit; and a display unit for displaying an image viewed from the arbitrary virtual view point the arbitrary virtual view point in the three-dimensional space based on viewpoint conversion image data generated by the viewpoint conversion unit, wherein the image generation apparatus further comprises a movement information calculating unit for calculating movement information relating to a movement of the camera unit installation body based on either of viewpoint conversion data generated by the viewpoint conversion unit, the spatial model or the mapped spatial data, wherein the display unit displays an image of an camera unit installation body model corresponding to the camera unit installation body and also the movement information calculated by the movement information calculating unit.

The image generation apparatus, according to the present invention, may be configured such that the movement information comprises either movement direction information for indicating a direction of movement, movement track information for indicating a predicted movement track, movement speed information for indicating a speed of movement, or movement destination information relating to a compass direction, place name, or landmark, for example, of a predicted movement destination.

The image generation apparatus, according to the present invention, maybe configured to further comprise a collision probability calculation unit for calculating a probability of the camera unit installation body model colliding with the spatial model based on either of the viewpoint conversion image data generated by the viewpoint conversion unit, the imaged image data expressing the imaged image, the spatial model, or the mapped spatial data, all of which are respectively corresponding to different clock times, wherein the display unit displays a part having a probability of collision calculated by the collision probability calculation unit by a different display pattern in an image of the camera unit installation body model which is displayed by superimposing with an image by the viewpoint conversion image data generated by the viewpoint conversion unit.

The image generation apparatus, according to the present invention, is preferably configured such that the display pattern is at least either one of a color, a bordering or a warning icon.

The image generation apparatus, according to the present invention, may be configured to further comprise a blind spot calculation unit for calculating blind spot information, which indicates a zone becoming a blind spot for a predetermined place of the camera unit installation body based on an camera unit installation body model expressed by data corresponding to the camera unit installation body, wherein the display unit displays the camera unit installation body model and also the blind spot information calculated by the blind spot calculation unit.

The image generation apparatus, according to the present invention, may also be configured to further comprise a second body recognition unit for recognizing a second body different from the camera unit installation body based on either the viewpoint conversion image data converted by the viewpoint conversion unit, the imaged image data expressing the imaged image, the spatial model, or the mapped spatial data; and a second body blind spot calculation unit for calculating body blind spot information of the second body which is recognized by the second body recognition unit and indicates a zone becoming a blind spot for the second body based on second body data for indicating data relating to a predetermined second body, wherein the display unit displays the camera unit installation body model and also the blind spot information relating to the aforementioned other body calculated by the other body blind spot calculation unit.

Additionally, the image generation apparatus, according to the present invention, is preferably configured such that the camera unit installation body or the second body maybe at least either one of a vehicle, a pedestrian, a building or a road structure body, for example.

According to one aspect of the present invention, an image generation apparatus of the present invention comprises one or a plurality of camera units, being mounted on an camera unit installation body, for imaging an image; an other body recognition unit for recognizing other body different from the camera unit installation body based on imaged data imaged by the camera unit; another body blind spot calculation unit for calculating other body blind spot information which is recognized by the other body recognition unit and indicates a zone becoming a blind spot for other body based on other body data for indicating data relating to a predetermined other body; a display unit for displaying the camera unit installation body model and also the blind spot information calculated by the other body blind spot calculation unit.

The image generation apparatus, according to the present invention, is preferably configured such that the camera unit installation body or the other body is at least either one of a vehicle, a pedestrian, a building, or a road structure body, for example.

Additionally, according to one aspect of the present invention, an image generation method of the present invention comprises the steps of mapping, in a spatial model, an image imaged by one or a plurality of camera unites that are mounted onto an camera unit installation body; generating viewpoint conversion image data viewed from the arbitrary virtual view point in a three-dimensional space based on the mapped spatial data; and displaying an image viewed from the arbitrary virtual view point in the three-dimensional space based on the generated viewpoint conversion image data, wherein the image generation method further comprises the step of calculating movement information relating to a movement of the camera unit installation body based on either of the generated viewpoint conversion data, the imaged image data expressing the imaged image, the spatial model, or the mapped spatial data, wherein the displaying displays an image of the camera unit installation body model and also the movement information together with the viewpoint conversion image.

According to one aspect of the present invention, an image generation program is for making a computer carry out the procedures of mapping, in a spatial model, an image imaged by one or a plurality of camera unit which are mounted onto an camera unit installation body; generating viewpoint conversion image data viewed from the arbitrary virtual view point in a three-dimensional space based on the mapped spatial data; and displaying an image viewed from the arbitrary virtual view point in the three-dimensional space based on the generated viewpoint conversion image data, wherein the image generation program further comprises calculating movement information relating to a movement of the camera unit installation body based on either of the generated viewpoint conversion data, the imaged image data expressing the imaged image, the spatial model, or the mapped spatial data, wherein the display displays an image of the camera unit installation body model and the movement information together with the viewpoint conversion image.

According to one aspect of the present invention, an image generation method is executed by a computer which carries out the process of imaging an image by one or a plurality of camera unit that are mounted onto an camera unit installation body; recognizing a second body different from the camera unit installation body based on the imaged image data; calculating second body blind spot information that indicates a zone becoming a blind spot of the recognized second body based on the second body data that indicates data relating to a predetermined second body; and displaying the calculated second body blind spot information together with the camera unit installation body model.

According to one aspect of the present invention, an image generation program is disclosed for making a computer carry out the procedures of imaging an image by one or a plurality of camera unit that are mounted onto an camera unit installation body; recognizing a second body different from the camera unit installation body based on the imaged image data; calculating the second body blind spot information that indicates a zone becoming a blind spot of the recognized second body based on the second body data which indicates data relating to a predetermined second body; and displaying the calculated second body blind spot information together with the camera unit installation body model.

### BRIEF DESCRIPTION OF THE DRAWINGS

FIG. 1 is a block diagram of an image generation apparatus for generating a viewpoint conversion image by generating a spatial model by a distance measurement apparatus;

FIG. 2 is a block diagram of an image generation apparatus for generating a viewpoint conversion image by generating a spatial model by an camera unit;

FIG. 3 is a block diagram of an image generation apparatus for the purpose of displaying movement information in a viewpoint conversion image by generating a spatial model by a distance measurement apparatus;

FIG. 4 shows an appearance of a possible vision observed by a driver while driving a vehicle;

FIG. 5 shows a display example of displaying movement direction information;

FIG. 6 shows a display example of displaying movement track information;

FIG. 7 shows a display example of displaying movement speed information;

FIG. 8 shows a display example of displaying movement destination information;

FIG. 9 shows a display example of displaying a display feature of an image according to a probability of two bodies colliding with each other, together with a display of movement information;

FIG. 10A is a drawing for the purpose of describing blind spots (part 1);

FIG. 10B is a drawing for the purpose of describing blind spots (part 2);

FIG. 11 shows a display example of displaying blind spot information;

FIG. 12 shows a display example of displaying other body blind spot information;

FIG. 13 is a block diagram of an image generation apparatus for displaying movement information in a viewpoint conversion image by generating a spatial model by an camera unit;

FIG. 14 is a flow chart showing a flow of an image generation process for displaying movement information, probability of collision, blind spot information and other body blind spot information in a viewpoint conversion image;

FIG. 15 is a block diagram of an image generation apparatus for displaying other body blind spot information;

FIG. 16 shows a display example of displaying other body blind spot information;

FIG. 17 is a flow chart showing a flow of an image generation process for displaying other body blind spot information;

FIG. 18 shows the relationship between the owner vehicle and other vehicle used in describing a calculation example of a probability of collision; and

FIG. 19 shows a relative vector for the purpose of describing a calculation example of a probability of collision.

### DETAILED DESCRIPTION OF THE PREFERRED EMBODIMENTS

The following is a detailed description of the preferred embodiment of the present invention while referring to the accompanying drawings.

Note that the present invention has imported the technical content disclosed by the above noted patent document 1.

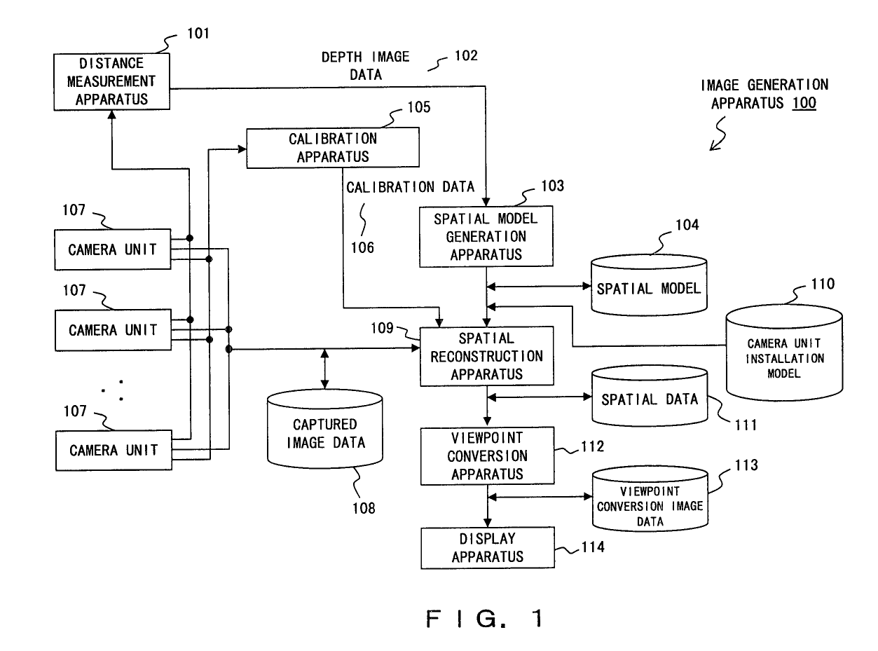

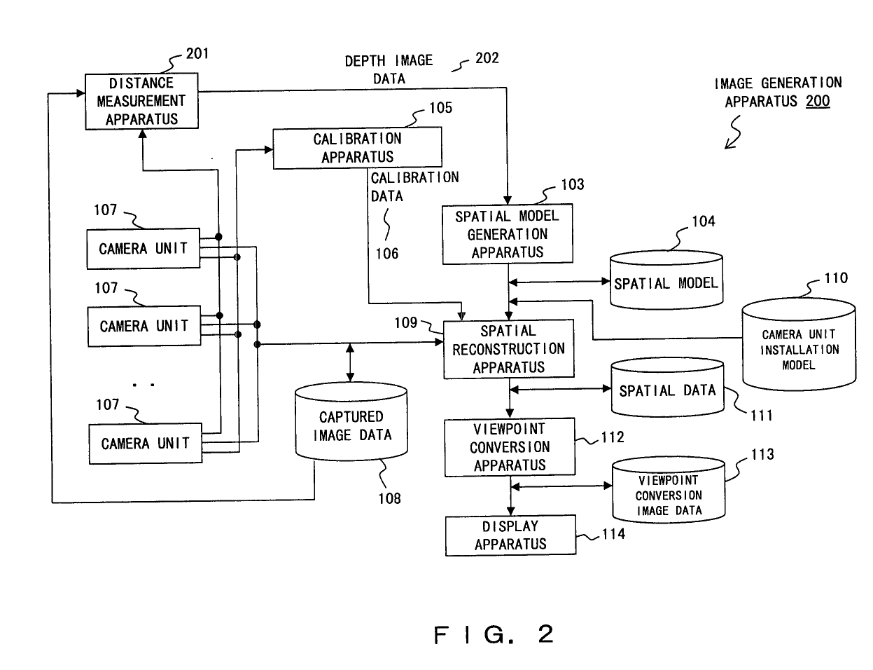

The first description is of an image generation apparatus for generating an image viewed from a virtual viewpoint based on image data captured by a plurality of cameras and displaying the image from the virtual viewpoint by using FIGS. 1 and 2. Note that while the example shown by the drawings uses a plurality of cameras, imaged data, however, may be obtained in the same case as a plurality of cameras by one camera moving the installation position sequentially. This camera or these cameras are installed in a vehicle, room (in its specific part, for example), pedestrian, building, or a road structure body, for example, as a camera unit installation body. This aspect is the same for each embodiment described below.

FIG. 1 is a block diagram of an image generation apparatus for generating a viewpoint conversion image by generating a spatial model by a distance measurement apparatus.

Referring to FIG. 1, the image generation apparatus 100 comprises a distance measurement apparatus 101, a spatial model generation apparatus 103, a calibration apparatus 105, one or a plurality of camera unites 107, a spatial reconstruction apparatus 109, a viewpoint conversion apparatus 112, and a display apparatus 114.

The distance measurement apparatus 101 measures a distance to a target body (i.e., an obstacle) by using a distance sensor for measuring distance. For example, when mounted on a vehicle, the distance measurement apparatus 101 measures a distance to an obstacle existing at least in the vehicle's surroundings, for example by using a distance sensor, as a situation of the vehicle surround.

The spatial model generation apparatus 103 generates a spatial model 104 of a three-dimensional space based on depth image data 102 measured by the distance measurement apparatus 101 and stored in a data base (by delineating a concept as if it was a reality: likewise in the following). Note that the spatial model 104 may be either generated based on measurement data by a specific sensor as described above, predetermined, or generated from a plurality of input images dynamically, whose data is stored in a database.

The camera unit 107, a camera for example, images an image when mounted on a camera unit installation body and stores the image in a database as captured image data 108. If the camera unit installation body is a vehicle, the camera unit 107 captures an image of the vehicle's surroundings.

The spatial reconstruction apparatus 109 maps captured image data 108 imaged by the camera unit 107 in a spatial model 104 generated by the spatial model generation apparatus 103. Then the mapped data of the captured image data 108 in the spatial model 104 is stored in a database as spatial data 111.

The calibration apparatus 105 obtains parameters, such as a mounting position, mounting angle, correction value for a lens distortion, and focal length of the lens for the camera unit 107 by input or calculation. For example, in order to correct for lens distortion, the calibration parameters are used to perform a camera calibration of the camera unit 107 when it is a camera. The camera calibration is defined as determining and correcting camera parameters indicating the above described camera characteristics, such as a camera mounting position, camera mounting angle, correction value for a lens distortion of the camera and lens focal distance thereof, of the camera in a three-dimensional real world in which the camera is installed.

The viewpoint conversion apparatus 112 generates viewpoint conversion image data 113 to store it in a database, and is viewed from the arbitrary virtual view point in a three-dimensional space based on spatial data 111 mapped by the spatial reconstruction apparatus 109.

The display apparatus 114 displays an image viewed from the arbitrary virtual view point in the three-dimensional space based on the viewpoint conversion image data 113 generated by the viewpoint conversion apparatus 112.

FIG. 2 is a block diagram of an image generation apparatus for generating a viewpoint conversion image by generating a spatial model by an camera unit. The image generation apparatus 200 comprises a distance measurement apparatus 201, a spatial model generation apparatus 103, a calibration apparatus 105, one or a plurality of camera unites 107, a spatial reconstruction apparatus 109, a viewpoint conversion apparatus 112 and a display apparatus 114.

Wherein the image generation apparatus 200 may differ from the image generation apparatus 100, described by using FIG. 1, such that the former comprises the distance measurement apparatus 201 in place of the distance measurement apparatus 101. The following is a description of the distance measurement apparatus 201, although other components are not describe, the descriptions thereof are similar to the description regarding FIG. 1.

The distance measurement apparatus 201 measures a distance to an obstacle based on captured image data 108 captured by the camera unit 107. This is commonly carried out by the method of a stereo distance measurement for searching corresponding points in images of a plurality of cameras capturing a single field of view, calculating parallaxes among the images and calculating a depth by the principles of triangulation. Additionally, distance data 202 may be obtained by combining data measuring the distance to an obstacle by using a distance sensor for measuring a distance, as in the case of the distance measurement apparatus 101.

The spatial model generation apparatus 103 generates a spatial model 104 in a three-dimensional space based on distance data measured by the distance measurement apparatus 201 and stored in a database.

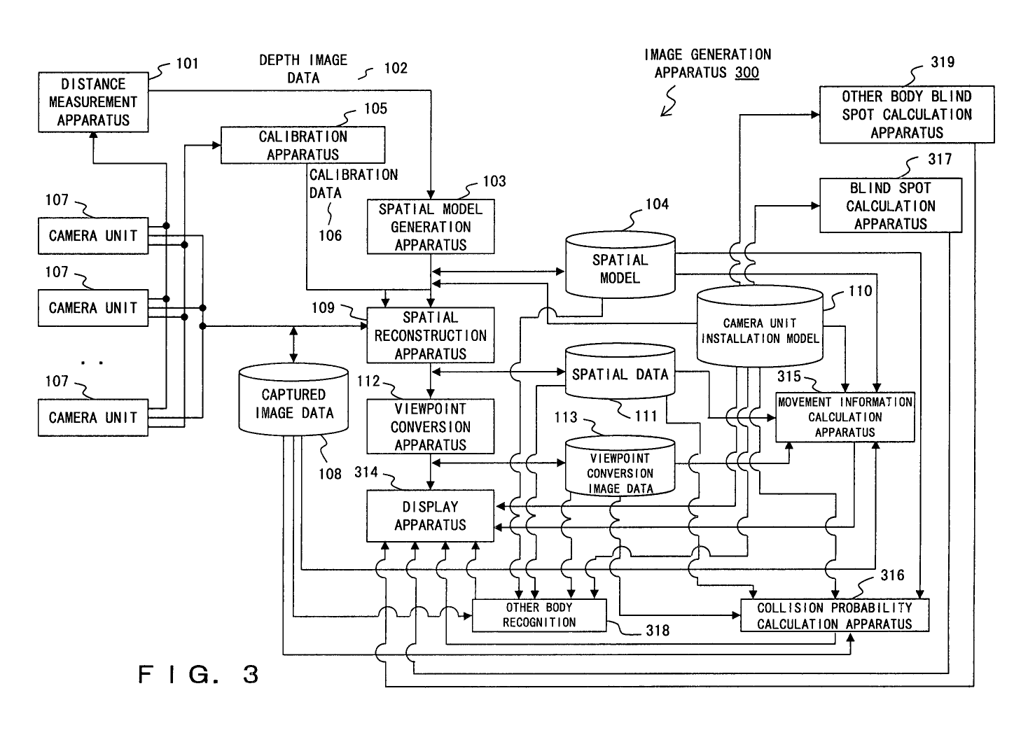

The next description of FIGS. 3 through 13 discusses an image generation apparatus capable of generating image data for displaying information relating to a movement of a moving body, in an intuitively comprehensible manner, by displaying an image of a virtual viewpoint from the body that is based on a plurality of images captured by one or a plurality of cameras mounted on the aforementioned body such as a vehicle. The image generation apparatus can be applied to the image generation apparatus described by using FIGS. 1 or 2.

FIG. 3 is a block diagram of an image generation apparatus for displaying movement information in a conversion image by generating a spatial model by a distance measurement apparatus.

Referring to FIG. 3, the image generation apparatus 300 comprises a distance measurement apparatus 101, a spatial model generation apparatus 103, a calibration apparatus 105, one or a plurality of camera unites 107, a spatial reconstruction apparatus 109, a conversion apparatus 112, a display apparatus 114, a movement information calculation apparatus 315, a collision probability calculation apparatus 316, a blind spot calculation apparatus 317, an other body recognition apparatus 318, and an other body blind spot calculation apparatus 319.

The difference between the image generation apparatus 300 and the image generation apparatus 100 described by using FIG. 1 is that the former comprises the movement information calculation apparatus 315, the collision probability calculation apparatus 316, the blind spot calculation apparatus 317, the second body recognition apparatus 318, and the second body blind spot calculation apparatus 319. The following description is centered on the movement information calculation apparatus 315, the collision probability calculation apparatus 316, the blind spot calculation apparatus 317, the second body recognition apparatus 318, and the second body blind spot calculation apparatus 319. Although other components are not discussed herein, the description provided would be similar. The movement information calculation apparatus 315 calculates movement information relating to movement of the camera unit installation body based on either of the viewpoint conversion image data 113 generated by the viewpoint conversion apparatus 112, the captured image data 108 for indicating the imaged image, the spatial model 104, or the mapped spatial data 111. The movement information relating to movement of the camera unit installation body includes movement direction information for indicating a direction of movement, movement track information for indicating a predicted movement track, movement speed information for indicating a speed of movement, or movement destination information relating to, for example, a compass direction, place name, or landmark, of a predicted movement destination.

The display apparatus 314 displays the movement information calculated by the movement information calculation apparatus 315 as well as the image of the camera unit installation body model that corresponds to the camera unit installation body.

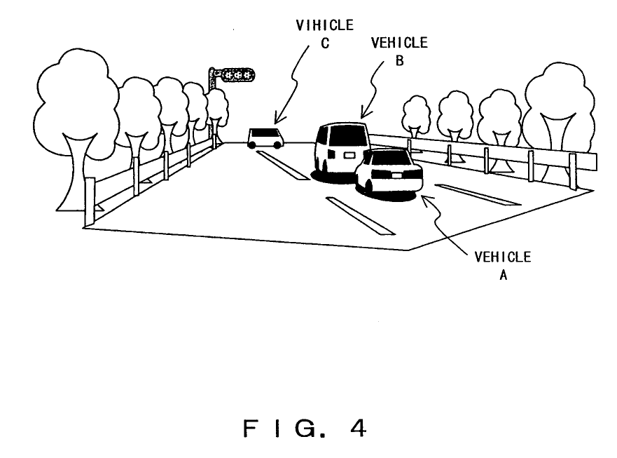

The following description is of an embodiment applying the image generation apparatus 300 to a system for monitoring a vehicle's surroundings by using FIGS. 4 through 8.

FIG. 4 shows an appearance of a possible view observed by a driver when driving a vehicle. The driver sees three vehicles, i.e., vehicles A, B and C, on the road.

A distance sensor is mounted on the vehicle (i.e., a distance measurement apparatus 101) for measuring a distance to an obstacle existing in the vehicle's surroundings. A plurality of cameras (i.e., camera unites 107) are mounted on the vehicle for capturing images of the vehicle's surroundings.

The spatial model generation apparatus 103 generates a spatial model of a three-dimensional space based on the depth image data 102 measured by the distance sensor to store in a database. The camera captures images of the vehicle's surroundings to store in a database as the captured image data 108.

The spatial reconstruction apparatus 109 maps the captured image data 108 captured by the camera in the spatial model 104 generated by the spatial model generation apparatus 103 to store in a as the spatial data 111.

For example, the viewpoint conversion apparatus 112 sets a virtual viewpoint over and behind the vehicle for example and generates viewpoint conversion image data 113 viewed from the virtual viewpoint to store it in a database based on the spatial data 111 mapped by the spatial reconstruction apparatus 109.

The movement information calculation apparatus 315 calculates movement information relating to a movement of the camera unit installation body, that is, movement direction information indicating a direction of movement, movement track information indicating a predicted movement track, movement speed information for indicating a speed of movement, and movement destination information relating to, for example, a compass direction, place name or landmark, of a predicted movement destination, based on either of the viewpoint conversion image data 113 generated by the viewpoint conversion apparatus 112, the captured image data 108 for indicating the imaged image, the spatial model 104, or the mapped spatial data 111.

The display apparatus 314, for example, is usually installed in a vehicle and shared with a monitor display for a car navigation system and displays movement information such as the movement direction information calculated by the movement information calculation apparatus 315 together with an image of a camera unit installation body model 110 corresponding to the camera unit installation body when displaying an image viewed from a discretionary viewpoint in the three-dimensional space based on the viewpoint conversion image data 113 generated by the viewpoint conversion apparatus 112.

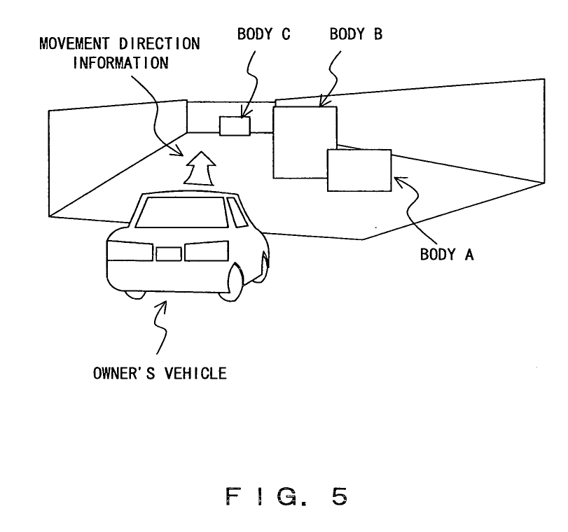

FIG. 5 shows a display example of displaying movement direction information. Body A is a viewpoint conversion image of vehicle A shown by FIG. 4, and likewise body B is that of vehicle B and body C is that of vehicle C. The movement direction information for indicating a moving direction of the owner's vehicle is shown together with an owner's vehicle relation model based on the data stored by the camera unit installation body model 110.

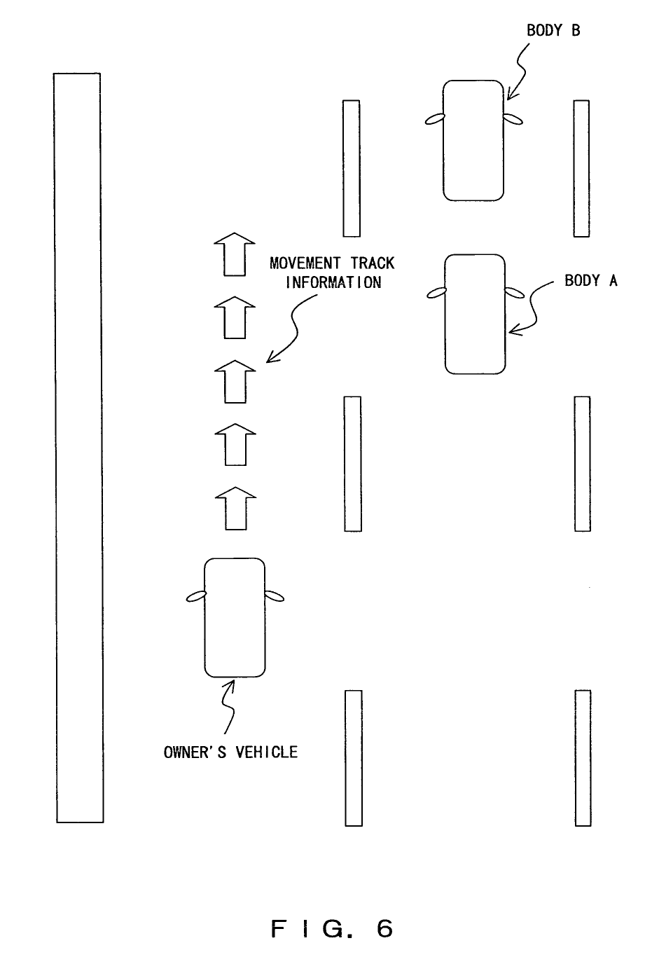

FIG. 6 shows a display example of displaying movement track information. While FIG. 6 is also a display example of a viewpoint conversion image, it is an example of a virtual viewpoint different from the one shown by FIG. 5. While the display example shown by FIG. 5 is a bird's eye view with its virtual viewpoint being placed over and behind the owner's vehicle, and looking forward therefrom, the display example shown by FIG. 6 is a plain view with its virtual viewpoint being placed over the owner's vehicle and looking down therefrom.

Referring to FIG. 6, body A is a viewpoint conversion image of vehicle A shown by FIG. 4, and likewise, body B is a viewpoint conversion image of vehicle B, whereas a body relating to vehicle C is not displayed. Movement track information for indicating a predicted movement track of the owner's vehicle is displayed together with the owner's vehicle relation model based on the data stored by the camera unit installation body model 110.

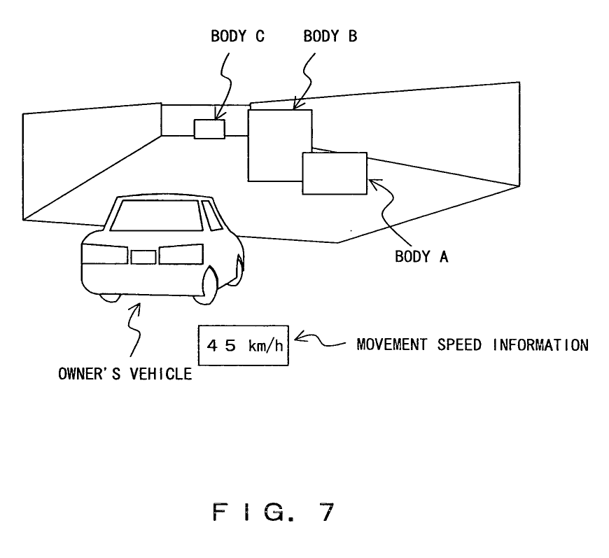

FIG. 7 shows a display example of displaying movement speed information. FIG. 7 is a bird's eye view with its virtual viewpoint being placed over and behind the owner s vehicle, and looking forward therefrom as with FIG. 5. The body A is a viewpoint conversion image of vehicle A shown by FIG. 4, and likewise body B being that of vehicle B and body C being that of vehicle C. Movement speed information for indicating a moving speed of the owner s vehicle is displayed together with the owner's vehicle relation model based on the data stored by the camera unit installation body model 110.

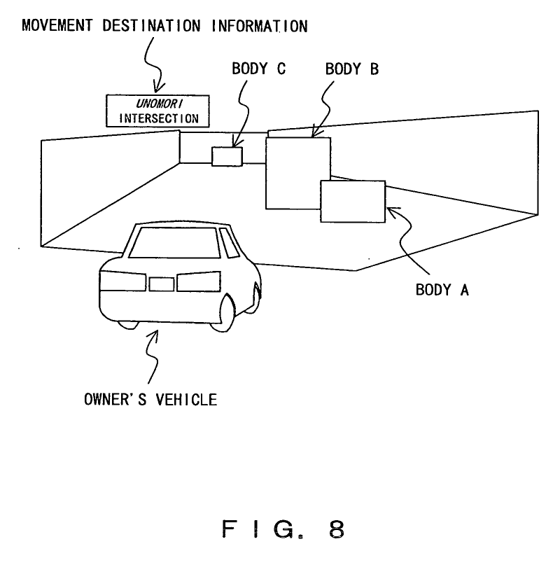

FIG. 8 shows a display example of displaying movement destination information. FIG. 8 is also a bird's eye view with its virtual viewpoint being placed over and behind the owner's vehicle, and looking forward therefrom as with FIG. 5, wherein body A is a viewpoint conversion image of vehicle A shown by FIG. 4, and body B being that of vehicle B and body C being that of vehicle C. Movement destination information relating to, for example, a compass direction, place name, or landmark, of the predicted movement destination of the owner's vehicle is displayed together with the owner's vehicle relation model based on the data stored by the camera unit installation body model 110.

Note that a configuration may be such that the pieces of movement information shown by FIGS. 5 through 8 are displayed simultaneously.

Referring again to the description of FIG. 3. The collision probability calculation apparatus 316 calculates a probability of the camera unit installation body model 110 colliding with the spatial model 104 corresponding to respectively different clock times based on either of the viewpoint conversion image data 113 generated by the viewpoint conversion apparatus 112, the captured image data 108 for indicating the imaged image, the spatial model 104, or the mapped spatial data 111.

A probability of a collision can easily be figured out by respective movement directions and movement speeds of two bodies, for example.

The display apparatus 314 displays a part having a probability of collision calculated by the collision probability calculation apparatus 316 in a different manner according to the probability of collision among the image of the camera unit installation body model 110 which is displayed in superimposition with the image expressed by the viewpoint conversion image data 113 that is generated by the viewpoint conversion apparatus 112, in addition to displaying the above described movement information. The display method is changed by a presence or absence of a warning icon or feature, for example, such as a presence or absence of color, a bordering or a thickness.

Note that the display apparatus 314 may be configured to display a background model integrating the applicable image or gradating the image if the probability of collision calculated by the collision probability calculation apparatus 316 is no more than a prescribed value. Additionally, it maybe configured to use colors as the applicable display aspect so that the meaning of displayed information is recognized.

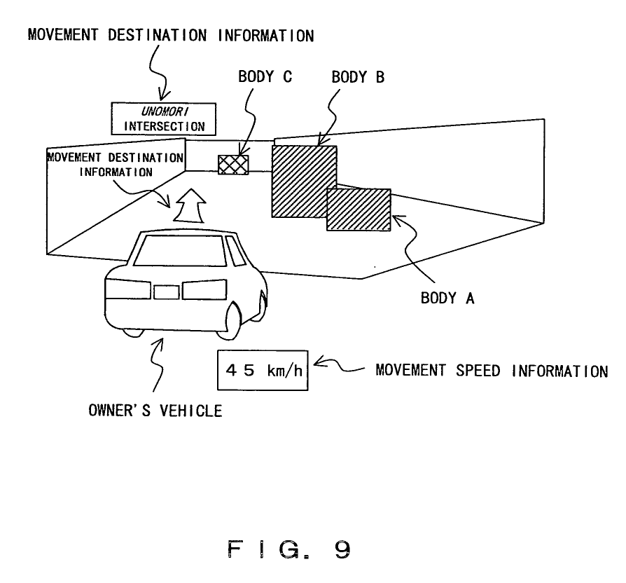

FIG. 9 shows a display example of displaying a display feature of an image according to a probability of two bodies colliding with each other, together with a display of movement information.

FIG. 9 is also a bird's eye view with its virtual viewpoint being placed over and behind the owner's vehicle, and looking forward therefrom as with FIG. 5, with body A being a viewpoint conversion image of the vehicle A shown by FIG. 4, and likewise body B being that of vehicle B and body C being that of vehicle C.

Additionally, movement direction information for indicating a direction of movement, movement track information for indicating a predicted movement track, movement speed information for indicating a speed of movement, and movement destination information relating to a compass direction, place, name, or landmark, for example, of a predicted movement destination among the movement information on the owner's vehicle are displayed together with the owner's vehicle relation model based on the data stored by the camera unit installation body model 110; and further the bodies A, B and C are displayed by different display features according to the probabilities of the owner's vehicle colliding with the bodies A, B and C, respectively. For example, body C, which is the viewpoint conversion image of vehicle C with the highest probability of collision with the owner's vehicle among the three other vehicles, is displayed in red, while bodies A and B, which are the viewpoint conversion images of vehicles A and B, respectively, with insubstantially high probability of collision as compared to the vehicle C, are displayed in yellow. Note that in the case of displaying with different display colors, the configuration may be such that at least either one of hue, saturation or brightness of color relating to the aforementioned displaying is changed.

Returning to the description of FIG. 3. The blind spot calculation apparatus 317 calculates blind spot information for indicating a zone becoming a blind spot for a predefined place of the camera unit installation body based on a camera unit installation body model 110 expressed by the data corresponding to the camera unit installation body. For example, if the camera unit installation body is a vehicle, the calculation is for a zone becoming a blind spot for the driver of the vehicle.

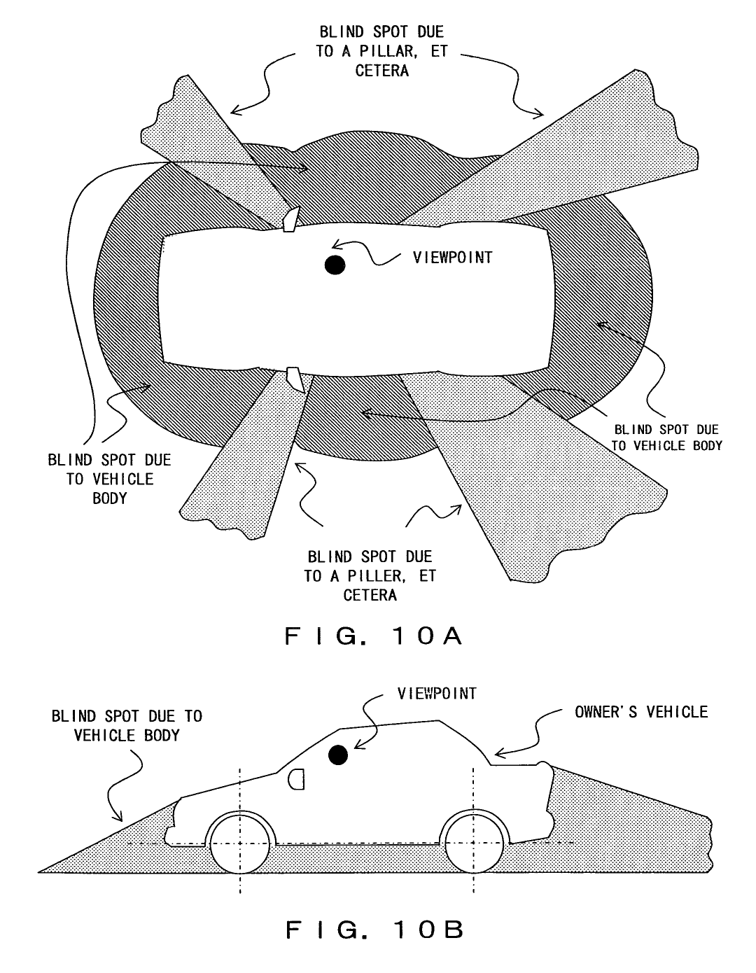

FIG. 10A and 10B are drawings for the purpose of describing blind spots.

Referring to FIG. 10A and 10B, the camera unit installation body is a vehicle, FIG. 10A is a plain view of a vehicle and FIG. 10B is a broad side view thereof. The zones becoming blind spots (e.g., blind spots due to a pillar, or due to the vehicle body) for the driver (i.e., the viewpoint of the driver) as a predefined place of the vehicle are indicated in FIG. 10B by the cross hatching.

The display apparatus 314 displays the blind spot information, which is calculated by the blind spot calculation apparatus 317, together with the camera unit installation body model 110. Here, the blind spot information is defined as a zone becoming a blind spot for the viewpoint of the driver.

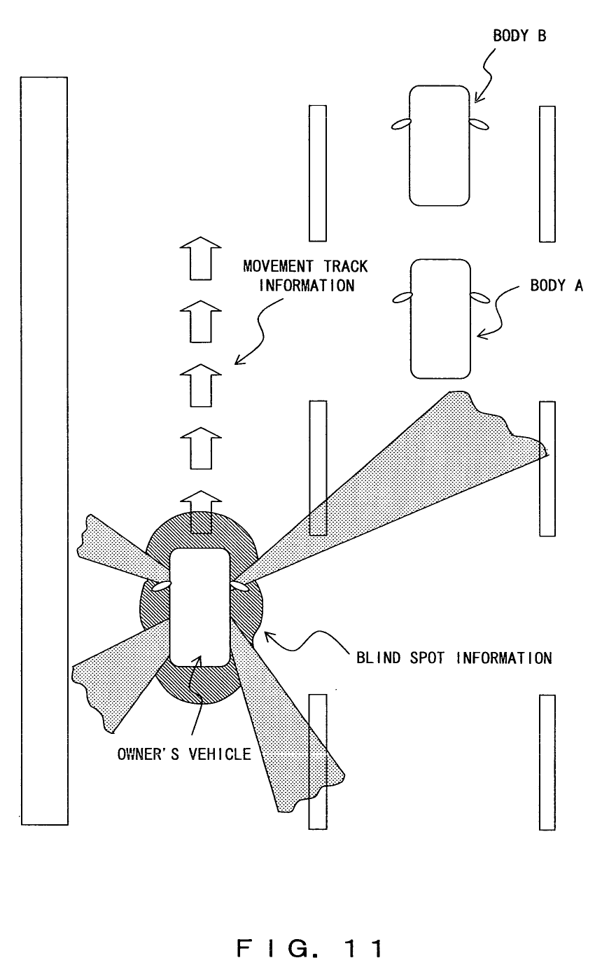

FIG. 11 shows a display example of displaying blind spot information.

Referring to FIG. 11, body A is a viewpoint conversion image of vehicle A shown by FIG. 4, and likewise body B is that of vehicle B, while a body corresponding to the vehicle C is not displayed. Zones becoming blind spots of the owner's vehicle as blind spot information are displayed together with the owner's vehicle relation model based on the data stored by the camera unit installation body model 110 and the movement track information as one of the movement information.

Returning to the description of FIG. 3., the second body recognition apparatus 318 recognizes a second body different from the camera unit installation body based on either of the viewpoint conversion image data 113 converted by the viewpoint conversion apparatus 112, the captured image data 108 for indicating the imaged image, the spatial model 104, or the mapped spatial data 111. For example, if the camera unit installation body is a vehicle, the recognized are a preceding vehicle, an oncoming vehicle, or a pedestrian, for example.

Furthermore, the second body blind spot calculation apparatus 319 calculates second body blind spot information for indicating a zone, which is recognized by the second body recognition apparatus 318, becoming a blind spot for second body based on the second body data for indicating the data relating to a predefined second body. For example, if the camera unit installation body is a vehicle and the second body different from the camera unit installation body is also a vehicle, then the calculated blind spot information is a zone becoming a blind spot of the driver of the vehicle that is the second body. Meanwhile, the zone second body data may also use a database storing the camera unit installation body model 110.

And the display apparatus 314 displays the blind spot information relating to the aforementioned second body calculated by the second body blind spot calculation apparatus 319 together with the camera unit installation body model 110.

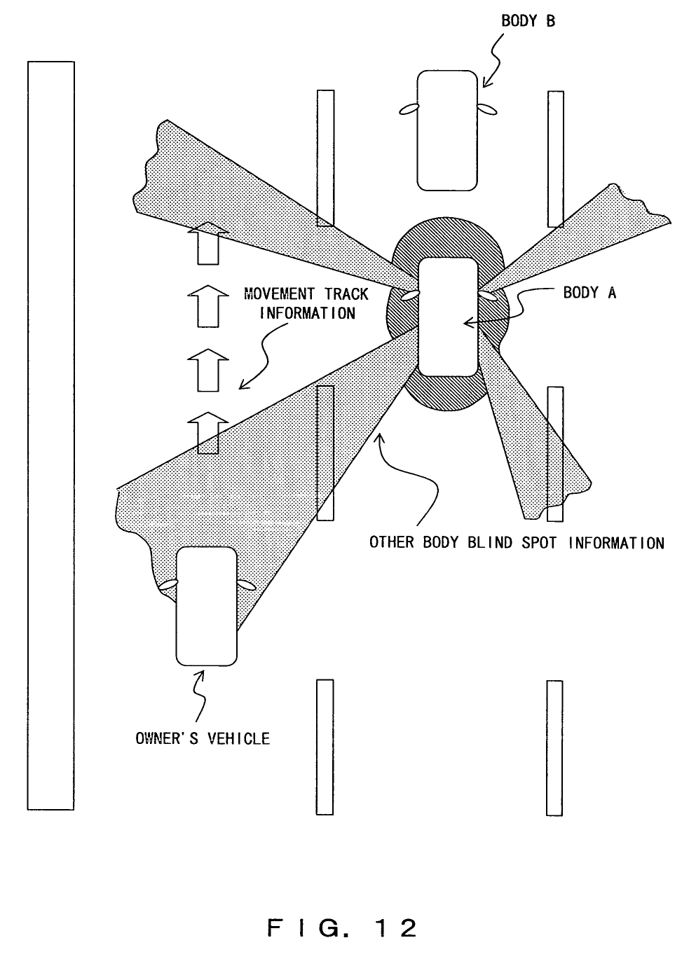

FIG. 12 shows a display example of displaying other body blind spot information.

Referring to FIG. 12, body A is a viewpoint conversion image of vehicle A shown by FIG. 4, and likewise body B is that of vehicle B, while a body corresponding to the vehicle C is not displayed. Body A is the second body recognized by the second body recognition apparatus 318, and the zones becoming blind spots of body A as the blind spot information of the second body are displayed together with the owner's vehicle relation model and the movement track information as one of the movement information. This makes it possible to recognize that the owner's vehicle is in a blind spot of the body A.

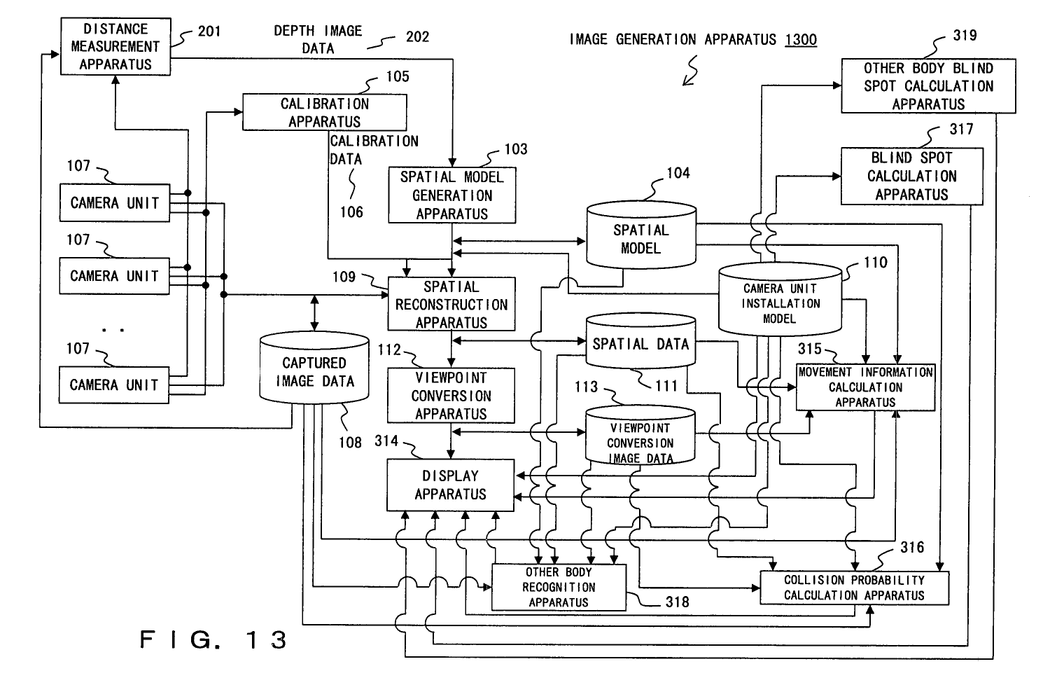

FIG. 13 is a block diagram of an image generation apparatus for the purpose of displaying movement information in a viewpoint conversion image by generating a spatial model by a camera unit.

Referring to FIG. 13, the image generation apparatus 1300 comprises a distance measurement apparatus 201, a spatial model generation apparatus 103, a calibration apparatus 105, one or a plurality of camera unites 107, a spatial reconstruction apparatus 109, a viewpoint conversion apparatus 112, a display apparatus 314, a movement information calculation apparatus 315, a collision probability calculation apparatus 316, a blind spot calculation apparatus 317, a second body recognition apparatus 318 and a second body blind spot calculation apparatus 319.

The difference between the image generation apparatus 1300 and the image generation apparatus 300 described by using FIG. 3 is that the former comprises the distance measurement apparatus 201 in place of the distance measurement apparatus 101. Note that the distance measurement apparatus 201 has been described by referring to FIG. 2 and therefore a description is omitted here.

The next description is of a flow of an image generation processing for generating image data in order to display information relating to a movement of a body during its movement in an intuitively comprehensible manner when displaying an image from a virtual viewpoint based on a plurality of images captured by one or a plurality of cameras mounted on a body such as a vehicle.

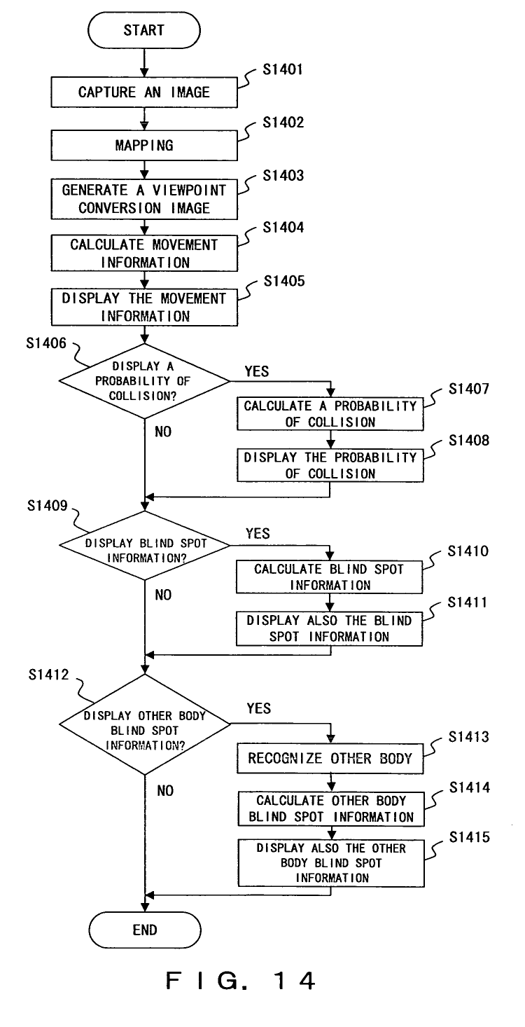

FIG. 14 is a flow chart showing a flow of an image generation processing for the purpose of displaying movement information, probability of collision, blind spot information and second body blind spot information in a viewpoint conversion image.

First, the step S1401 is to capture an image of a vehicle's surroundings by using a camera mounted on a body such as the aforementioned vehicle.

The step S1402 is to generate spatial data 111 by mapping the captured image data 108, which is the data of the image captured in the step S1401, in a spatial model 104.

The step S1403 is to generate a viewpoint conversion image data 113 viewed from the arbitrary virtual view point in a three-dimensional space based on the spatial data 111 mapped in the step S1402.

The next step S1404 is to calculate movement information relating to a movement of the camera unit installation body based on either of the generated viewpoint conversion image data 113, the captured image data 108, the spatial model 104, or the mapped spatial data 111.

The step S1405 is to display the movement information calculated in the step S1404, that is, the movement direction information for indicating the direction of movement, the movement track information for indicating the predicted movement track, the movement speed information for indicating the speed of movement, and the movement destination information relating to a compass direction, or a place name landmark, for example, when displaying an image viewed from the arbitrary virtual view point in a three-dimensional space.

Next, the step S1406 is to judge whether or not a displaying is appropriate for indicating a probability of the camera unit installation body model 110 colliding with the spatial model 104. For example, the judgment is made as to whether or not the displaying is appropriate by a presence or absence of an instruction from the user such as the driver of the vehicle.

If the judgment in the step S1406 is “the displaying is appropriate” (i.e., judged as “yes”), the step S1407 is to calculate a possibility of the camera unit installation body model 110 colliding with the spatial model 104 based on either of the generated viewpoint conversion image data 113, the captured image data 108, the spatial model 104, or the mapped spatial data 111, respectively corresponding to different clock times.

The step S1408 is to display a part having a probability of collision which is calculated by the collision probability calculation apparatus 316 in a different manner according to the probability thereof among the image of the camera unit installation body model 110 for displaying by superimposing with the image expressed by the viewpoint conversion image data 113 generated by the viewpoint conversion apparatus 112, in addition to the displaying of the movement information in the step S1405. The displaying is created by differentiating colors, bordering, or warning icon, for example.

After displaying the probability of collision in the step S1408, or if judged as not displaying a probability of collision in the step S1406 (“no” for the step S1406), then the step S1409 is to judge whether or not to display blind spot information for indicating a zone becoming a blind spot for a predefined place of the camera unit installation body. For example, the judgment is made as to whether or not the displaying is appropriate by a presence or absence of an instruction from the user, such as the driver of the vehicle.

If judged as a displaying in the step S1409 (i.e., judged as “yes”), then the step S1410 is to calculate blind spot information for indicating a zone becoming a blind spot for a predefined place of the camera unit installation body. That is, a zone becoming a blind spot for the driver of a vehicle if the camera unit installation body is the vehicle, for example, based on a camera unit installation body model 110 expressed by the data corresponding to the camera unit installation body.

Next, the step S1411 is to display blind spot information calculated by the blind spot calculation apparatus 317 together with the camera unit installation body model 110, in addition to displaying the movement information in the step S1405 and further displaying a probability of collision in the step S1408 depending upon a case.

After displaying the blind spot information in the step S1411, or if judged as not displaying blind spot information in the step S1409 (“no” for the step S1409), then the step S1412 is to judge whether or not to display second body blind spot information for indicating a zone becoming a blind spot of an second body. For example, the judgment is made as to whether or not the displaying is appropriate by a presence or absence of an instruction from the user such as the driver of the vehicle.

If judged as a displaying in the step S1412 (i.e., judged as “yes”), then the step S1413 is to recognize a second body different from the camera unit installation body, a preceding vehicle for example, based on either of the generated viewpoint conversion image data 113, the captured image data 108, the spatial model 104, or the mapped spatial data 111; and the step S1414 is to calculate second body blind spot information, being recognized by the second body recognition apparatus 318, for indicating a zone becoming a blind spot for a second body based on second body data for indicating the data relating to the second body. For example, if the camera unit installation body is a vehicle and the second body different from the camera unit installation body is also a vehicle, then the calculated blind spot zone is the one becoming a blind spot for the driver of the vehicle that is the second body. Meanwhile, the zone second body data can also use the database storing the camera unit installation body model 110.

The step S1415 is to display the blind spot information relating to a relevant second body calculated by the second body blind spot calculation apparatus 319 together with the camera unit installation body model in addition to displaying the movement information in the step S1405, and additionally, the probability of collision of the step S1408 or the blind spot information of the step S1411, depending on a possible case.

Such a flow of the image generation processing makes it possible to display movement information such as movement direction information in a viewpoint conversion image and, furthermore, a probability of collision, blind spot information or second body blind spot information at the same time.

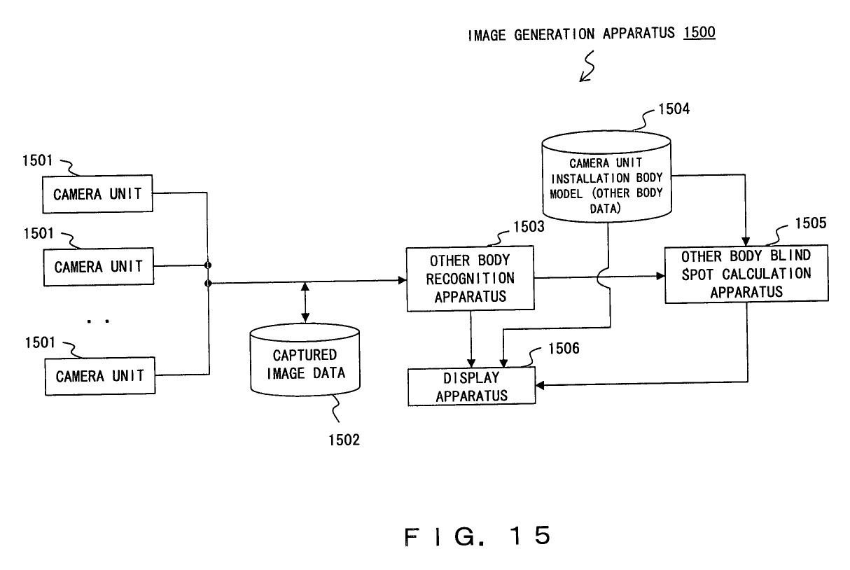

The next description is of an image generation apparatus capable of generating image data for the purpose of displaying a blind spot for a body within images in an intuitively comprehensible manner based on the images captured by one or a plurality of cameras mounted on a body such as a vehicle by using FIGS. 15 through 17.

FIG. 15 is a block diagram of an image generation apparatus for the purpose of displaying other body blind spot information.

Referring to FIG. 15, the image generation apparatus 1500 comprises one of a plurality of camera unites 1501, a second body recognition apparatus 1503, a second body blind spot calculation apparatus 1505 and a display apparatus 1506.

The camera unit 1501, such as a camera for example, images an image by being mounted on a camera unit installation body for storing in a database as captured image data 1502. If the camera unit installation body is a vehicle, the camera unit 1501 images an image of the vehicle's surroundings.

The second body recognition apparatus 1503 recognizes a second body different from the camera unit installation body based on the imaged data imaged by the camera unit 1501. If the camera unit installation body is a vehicle, the second body recognition apparatus 1503 recognizes a preceding vehicle, a noncoming vehicle, or a pedestrian, for example.

Furthermore, the second body blind spot calculation apparatus 1505 calculates second body blind spot information for indicating a zone becoming a blind spot for second body recognized by the second body recognition apparatus 1503 based on the second body data 1504 for indicating the data relating to a predetermined second body. For example, if the camera unit installation body is a vehicle and the second body different from the camera unit installation body is also a vehicle, then the calculated blind spot information is a zone becoming a blind spot for the driver of the vehicle that is the second body. Meanwhile, the zone second body data 1504 desirably uses a database storing the camera unit installation body model 1504.

The display apparatus 1506 displays the second body blind spot information, which is calculated by the second body blind spot calculation apparatus 1505, together with the camera unit installation body model 1504 that is the second body.

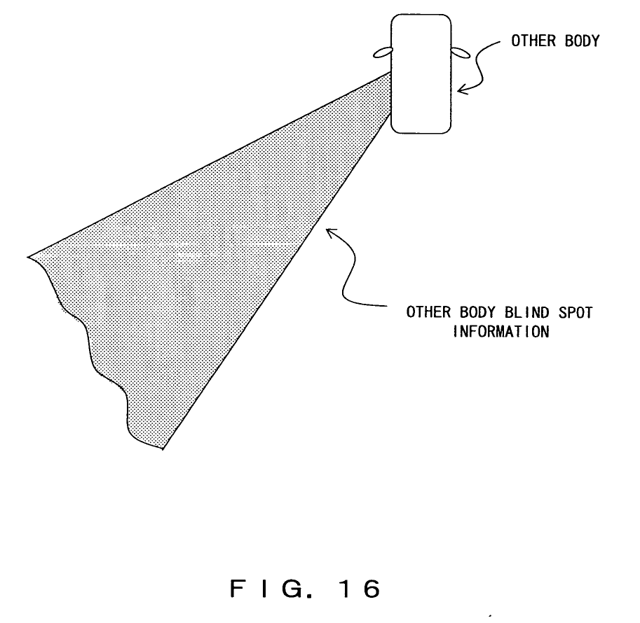

FIG. 16 shows a display example of displaying second body blind spot information.

Referring to FIG. 16, the second body is recognized based on an image captured by a camera and recognized as a preceding vehicle based on the second body data 1504. The second body blind spot information calculated based on the second body data 1504 is displayed. This enables a recognition of the fact that the owner's vehicle ends up being in a blind spot of the second body.

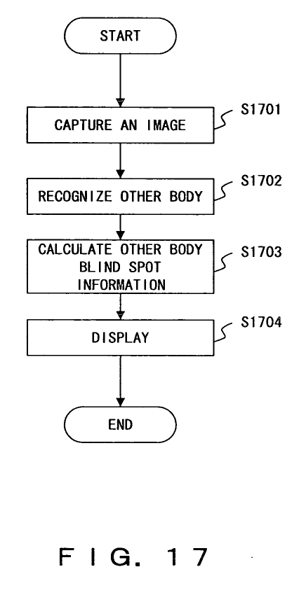

FIG. 17 is a flow chart showing a flow of an image generation processing for the purpose of displaying other body blind spot information.

First, the step S1701 is to capture an image of a vehicle's surroundings by using a camera mounted on a body such as a vehicle.

Next, the step S1702 is to recognize a second body different from the camera unit installation body, that is, a preceding vehicle, an oncoming vehicle, or a pedestrian, for example, based on the captured image data.

The next step S1703 is to calculate other body blind spot information for indicating a zone becoming a blind spot for the vehicle, for example, which is the recognized second body based on the second body data 1504 for indicating the data relating to a predefined second body.

The step S1704 is to display the second body blind spot information, which is calculated by the second body blind spot calculation apparatus 1505, together with the camera unit installation body model 1504 that is the second body. Meanwhile, if the owner's vehicle falls in the blind spot of the second body, the risk of collision maybe displayed by further changing the display features for a probability of collision as a riskier condition.

These embodiments can be expanded as described below.

The above described embodiments have defined a vehicle as an camera unit installation body and used images taken by the camera unites 107 and 1501 which are mounted thereon. This can be used in the same way even including an image of a monitor camera which is installed on a structure facing a road or in a shop floor if the camera parameter is either known, calculable or measurable. Also, as for the distance measurement apparatuses 101 or 201, distance information (e.g., depth image data 202) therefrom, respectively, installed on a structure facing a road or in a shop floor can be used if the distance measurement apparatuses 101 or 201 is installed in the same way as the camera, with the position and/or orientation being either known, calculable or measurable.

That is, the display apparatuses 114, 314 or 1506 for displaying a viewpoint conversion image and the camera unites 107 or 1501 need not be installed on a single camera unit installation body, rather the necessity is that there is a relatively moving obstacle.

Alternatively, comprisals of apparatuses may be such that pluralities of image generation apparatuses 100, 200, 300, 1300 and 1500 (e.ga plurality of the same kind of image generation apparatuses 100 or a plurality of different image generation apparatuses 100 and 200) mutually exchange data.

In these cases, communications with the respective image generation apparatuses 100, 200, 300, 1300 and 1500 are conducted by a communication apparatus comprising a coordinate conversion apparatus that carries out a coordinate conversion of each data or model of the above described embodiment according to the aspect of using each viewpoint and also included is a coordinate and an altitude calculation apparatus for calculating the reference coordinates.

The coordinate & altitude calculation apparatus is the one for calculating a position and altitude for generating a viewpoint conversion image, in which a coordinate of a virtual viewpoint may be set by using data of a latitude, longitude, altitude and compass direction by using the GPS (global positioning system), for example, or a coordinate conversion is carried out and a predefined viewpoint conversion image may be generated by calculating relative position coordinates vis-á-vis other image generation apparatuses 100, 200, 300, 1300 and 1500, and acquiring relative position coordinates within the group of the aforementioned image generation apparatuses 100, 200, 300, 1300 and 1500. This corresponds to a setup of a desired virtual viewpoint within those coordinates.

If an observer is a person, a comprisal may be so as to enable an observation of a viewpoint conversion image by wearing an head mounted display (HMD), for example, and to enable a measurement of a position, altitude and compass direction of the observer per se, which is picked up by a camera mounted on the camera unit installation body. It is also possible to parallelly use coordinate and altitude information measured by a GPS, gyro sensor, camera apparatus, human viewpoint detection apparatus, et cetera, which are mounted on a person that is the observer.

A setup of the viewpoint of the observer as a virtual viewpoint makes it possible to calculate movement information, probability of collision, or blind spot, for example, for the observer. This enables a person to grasp an obstacle for himself in a virtual viewpoint image displayed by the HMD, for example, recognize a suspicious individual, a dog, or a vehicle, for example, hiding behind the observer, and further use a multi-viewpoint conversion image generated more accurately and precisely even for a body existing in depth by using an camera unit installation body close thereto, an image of an image generation apparatus, and a spatial model.

The above described example shown by FIG. 4 uses red, yellow, green and blue in order of higher risk of collision according to the calculated probability thereof, the displaying, however, may be by differentiating these colors based simply on a distance or a relative speed.

For example, a guardrail part in a close distance with the owner's vehicle may be displayed in red, while the one in the distance (e.g., on the opposite lane) may be displayed in blue. And the road surface is displayed in blue or green even if it is close to the owner's vehicle since the road surface is a zone where a vehicle per se runs.

As for other vehicles among obstacles subjected to viewpoint conversion imaging, the other vehicles are displayed by differentiating colors according to changes of probabilities of collision by calculating a probability thereof based on a relative speed, or a distance, for example, displaying in red a vehicle with a high probability of collision at the time of calculation, and displaying in green a vehicle with a low probability thereof.

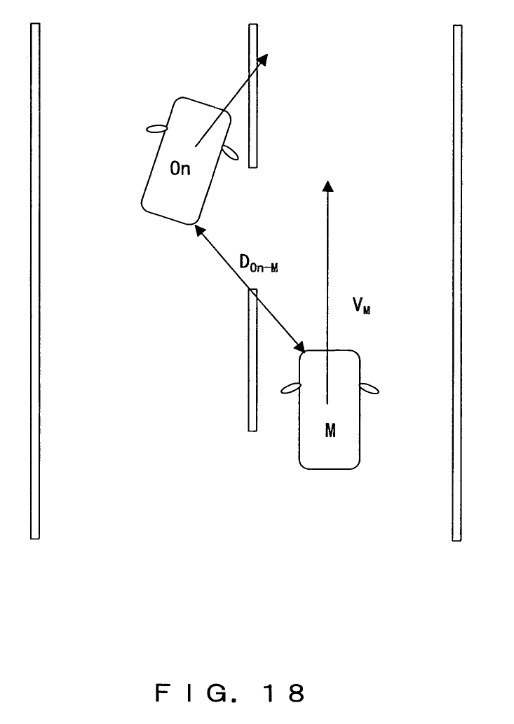

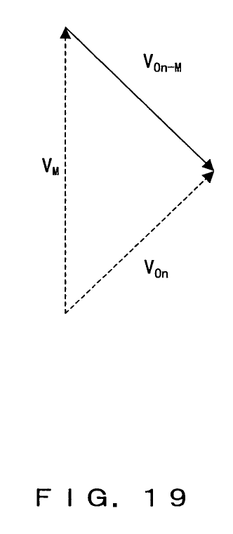

The next description is of a calculation example of a probability of collision refers to FIGS. 18 and 19.

FIG. 18 shows the relationship between the owner's vehicle and a second vehicle for the purpose of describing a calculation example of a probability of collision; and FIG. 19 shows a relative vector for the purpose of describing a calculation example of a probability of collision.

As shown by FIG. 18, considering an example relationship between the owner's vehicle M running upward on the right lane, as the drawing depicts, and the vehicle On is changing lanes while running likewise upward on the lane to the left of the owner's vehicle M, the following description applies.

A relative vector V_{On-M} between the vehicle On (at Vₒₙ) and the owner s vehicle M (at V_{M}) is acquired so that a value of a magnitude of the relative vector, i.e., |V_{On-M}| divided by the distance D between the vehicle On and the owner s vehicle M, i.e., (|V_{On-M}|)/D_{On-M}), is used as a probability of collision. A probability of collision may be acquired with a higher sensitivity by dividing by the D_{On-M} squared (i.e., (D_{On-M})²) in lieu of dividing by the distance D_{On-M} in the case of assuming a high probability of collision due to a closer distance, for example.

The present embodiment is configured to change displays of a viewpoint converted image of a zone having a high probability of collision by different hues based on the distance and relative speed between the owner s vehicle and a second body, and the probability of collision calculated based on the aforementioned pieces of information.

A degree of a probability of collision may be indicated by making a viewpoint conversion image display fuzzily. For example, a fuzzier display for a body with a low probability of collision while a clearer display for a body with a higher probability of collision in lieu of depicting it fuzzy, this makes it possible to easily recognize a body with a high probability of collision.

This configuration enables a driver or a pedestrian to recognize a risk of collision more intuitively, thereby assisting to accomplish safe driving or walking.

Each of the above described embodiments may be configured so that the plurality of camera unites comprise a three-lens stereo camera by themselves or a four-lens stereo camera thereby, in addition to the above described case of two-lens stereo camera. Such a use of three-lens or four-lens stereo cameras is known to provide a higher reliability, stable processing results in a three-dimensional reconstruction processing, for example (e.g., refer to “Highly functioned three-dimensional visual system” authored by TOMITA, Fumiaki; “Information Processing” volume No. 42, ser. No. 4; published by the Information Processing Society of Japan). It is known that an installation of a plurality of cameras in order to have base-line lengths in two directions enables a three-dimensional reconstruction in a more complex scene. An installation of a plurality of cameras in one base-line length direction enables an accomplishment of a stereo camera in so called multi-baseline system, thereby enabling a higher precision stereo measurement.

It is only reasonable that the case of a moving body such as a vehicle, other than a person, is applicable to the above described embodiments.

As described above, although the respective embodiments of the present invention have been described by referring to the accompanying drawings, it also goes without saying that an image generation apparatus applied by the present invention may be configured as a single apparatus, a system or integrated apparatus comprising a plurality of apparatuses, or a system for carrying out a processing by way of a network such as a LAN, WAN, et cetera, provided that the function of the aforementioned image generation apparatus is carried out, in lieu of being limited by the above described embodiments.

The aforementioned image generation apparatus can also be accomplished by a system comprising a CPU, a memory such as ROM and RAM, an input apparatus, an output apparatus, an external storage apparatus, a media drive apparatus, a portable storage medium and/or a network connection apparatus, all of which are connected to a bus. That is, it goes without saying that the aforementioned image generation apparatus can also be accomplished by supplying the image generation apparatus with a memory such as ROM, RAM, an external storage apparatus and a portable storage apparatus which record a software program code for achieving a system according to the above described embodiments, and/or by the computer comprised by the image generation apparatus reading out and executing the program code.

In this case, the program code per se read out of the portable storage medium, for example, accomplishes the new function of the present invention, and the portable storage medium, for example, storing the program code can be implemented in the present invention.

The portable storage medium for supplying the program code can use a flexible disk, hard disk, optical disk, magneto optical disk, CD-ROM, CD-R, DVD-ROM, DVD-RAM, magnetic tape, nonvolatile memory card, ROM card and/or other various storage media that are respectively recorded by way of a network connection apparatus (e.g., a telecommunication line) such as e-mail and a personal computer telecommunication, for example.

The functions of the above described respective embodiments are accomplished by a computer executing a program code that has been read out to the memory. The functions of the above described respective embodiments are also accomplished by a processing as a result of the operating system (OS), which operates in the computer, carrying out a part, or the entirety, of the actual processing.

Furthermore, the functions of the above described respective embodiments may be accomplished by a program code read out of a portable storage medium or a program (and data) provided by a program (and data) provider being written in a memory comprised by a function extension board inserted to a computer or a function extension unit connected thereto, followed by a CPU, comprised by the function extension board or the function extension unit executing a part, or the entirety of, the actual processing.

The present invention can adopt various comprisals or configurations within the scope thereof in lieu of being limited by the above described respective embodiments.

The present invention makes it possible to display the relationship between a body and a captured image in an intuitively comprehensible manner when displaying an image based on a plurality of images captured by one or a plurality of cameras mounted on a camera unit installation body such as a vehicle.

What is claimed is:

1. An image generation apparatus comprising one or a plurality of camera units, being mounted onto an camera unit installation body, for imaging an image;
a spatial reconstruction unit for mapping an image imaged by the camera unit in a spatial model;
a viewpoint conversion unit for generating viewpoint conversion image data viewed from the arbitrary virtual view point in a three-dimensional space based on spatial data mapped by the spatial reconstruction unit; and
a display unit for displaying an image viewed from the arbitrary virtual view point in the three-dimensional space based on viewpoint conversion image data generated by the viewpoint conversion unit, wherein
the image generation apparatus further comprises
a movement information calculating unit for calculating movement information relating to a movement of the camera unit installation body based on either of viewpoint conversion data generated by the viewpoint conversion unit, the spatial model or the mapped spatial data, wherein
the display unit displays an image of an camera unit installation body model corresponding to the camera unit installation body and also the movement information calculated by the movement information calculating unit.

2. The image generation apparatus according to claim 1, wherein
said movement information is either of movement direction information for indicating a direction of movement, movement track information for indicating a predicted movement track, movement speed information for indicating a speed of movement, or movement destination information relating to a compass direction, place name landmark, et cetera, of a predicted movement destination.

3. The image generation apparatus according to claim 1, further comprising
a collision probability calculation unit for calculating a probability of said camera unit installation body model colliding with said spatial model based on either of said viewpoint conversion image data generated by said viewpoint conversion unit, said imaged image data expressing said imaged image, said spatial model, or said mapped spatial data, all of which are corresponding to respectively different clock times, wherein
said display unit displays a part having a probability of collision calculated by the collision probability calculation unit by a different display pattern in an image of the camera unit installation body model which is displayed by superimposing with an image by the viewpoint conversion image data generated by the viewpoint conversion unit.

4. The image generation apparatus according to claim 3, wherein
said display pattern is at least either one of a color, a bordering or a warning icon.

5. The image generation apparatus according to claim 1, further comprising
a blind spot calculation unit for calculating blind spot information which indicates a zone becoming a blind spot for a predetermined place of said camera unit installation body based on a camera unit installation body model expressed by data corresponding to the camera unit installation body, wherein
said display unit displays the camera unit installation body model and also the blind spot information calculated by the blind spot calculation unit.

6. The image generation apparatus according to claim 1, further comprising
a second body recognition unit for recognizing a second body different from said camera unit installation body based on either of said viewpoint conversion image data converted by said viewpoint conversion unit, said imaged image data expressing said imaged image, said spatial model, or said mapped spatial data; and
a second body blind spot calculation unit for calculating second body blind spot information which is recognized by the second body recognition unit and indicates a zone becoming a blind spot for the second body based on other body data for indicating data relating to a predetermined second body, wherein
said display unit displays said camera unit installation body model and also the blind spot information relating to the aforementioned second body calculated by the second body blind spot calculation unit.

7. The image generation apparatus according to claim 1, wherein
said camera unit installation body or said second body is at least either one of a vehicle, a pedestrian, a building or a road structure body.

8. An image generation apparatus, comprising:
one or a plurality of camera units, being mounted onto an camera unit installation body, for imaging an image;
a second body recognition unit for recognizing a second body different from the camera unit installation body based on imaged data imaged by the camera unit;
a second body blind spot calculation unit for calculating second body blind spot information which is recognized by the second body recognition unit and indicates a zone becoming a blind spot for the second body based on second body data for indicating data relating to a predetermined second body;
a display unit for displaying the camera unit installation body model and also the blind spot information calculated by the second body blind spot calculation unit.

9. The image generation apparatus according to claim 8, wherein
said camera unit installation body or said second body is at least either one of a vehicle, a pedestrian, a building or a road structure body.

10. An image generation method, comprising the steps of
mapping, in a spatial model, an image imaged by one or a plurality of camera unit which are mounted onto an camera unit installation body;
generating viewpoint conversion image data viewed from the arbitrary virtual view point in a three-dimensional space based on the mapped spatial data; and
displaying an image viewed from the arbitrary virtual view point in the three-dimensional space based on the generated viewpoint conversion image data, wherein the image generation method further comprises the step of
calculating movement information relating to a movement of the camera unit installation body based on either of the generated viewpoint conversion data, the imaged image data expressing the imaged image, the spatial model or the mapped spatial data, wherein
the displaying displays an image of the camera unit installation body model and also the movement information together with the viewpoint conversion image.

11. An image generation program for making a computer carry out the procedures of
mapping, in a spatial model, an image imaged by one or a plurality of camera unit which are mounted onto an camera unit installation body;
generating viewpoint conversion image data viewed from the arbitrary virtual view point in a three-dimensional space based on the mapped spatial data; and
displaying an image viewed from the arbitrary virtual view point in the three-dimensional space based on the generated viewpoint conversion image data, wherein the image generation program further comprises the procedure of
calculating movement information relating to a movement of the camera unit installation body based on either of the generated viewpoint conversion data, the imaged image data expressing the imaged image, the spatial model or the mapped spatial data, wherein
the displaying displays an image of the camera unit installation body model and also the movement information together with the viewpoint conversion image.

12. An image generation method for being executed by a computer which carries out the processing of
imaging an image by one or a plurality of camera unit which are mounted onto an camera unit installation body;
recognizing a second body different from the camera unit installation body based on the imaged image data;
calculating second body blind spot information which indicates a zone becoming a blind spot of the recognized second body based on second body data which indicates data relating to a predetermined second body; and
displaying the calculated second body blind spot information together with the camera unit installation body model.

13. An image generation program for making a computer carry out the procedures of
imaging an image by one or a plurality of camera unites which are mounted on an camera unit installation body;
recognizing second body different from the camera unit installation body based on the imaged image data;
calculating second body blind spot information which indicates a zone becoming a blind spot of the recognized second body based on second body data which indicates data relating to a predetermined second body; and
displaying the calculated second body blind spot information together with the camera unit installation body model.
